(19) United States
(12) Patent Application Publication
(10) Pub. No.: US 2008/0008048 A1
(43) Pub. Date: Jan. 10, 2008

(54) Microcomputer safe medication reminder manager

(76) Inventor: Chung-Hua Huang, Danshuei Township (TW)

Correspondence Address: TROXELL LAW OFFICE PLLC, 5205 LEESBURG PIKE, SUITE 1404, FALLS CHURCH, VA, 22041, US

(21) Appl. No.: 11/480,942

(22) Filed: Jul. 6, 2006

(51) Int. Cl. G04B 47/00

(52) U.S. Cl. 368/10

(57) ABSTRACT

The present invention provides a microcomputer safe medication reminder manager that includes an electronic medicine storage case and a timing device. A support base is located on the electronic medicine storage case, and medicine boxes are located on the support base. The medicine boxes are separated into a plurality of medicine compartments, and indicator lights are correspondingly located on the support base and coupled to match each of the medicine compartments. The timing device is electrically connected to the electronic medicine storage case, thereby enabling the timing device to control flickering of the corresponding indicator lights. Accordingly, the present invention is provided with convenience of use, portability and effectiveness to remind a user of times when to take medicine and exact location of the medicine.

### BACKGROUND OF THE INVENTION

(a) Field of the Invention

The present invention relates to a microcomputer safe medication reminder manager, and more particularly to a configuration assembled by mutual disposition of an electronic medicine storage case and a timing device provided with multifunction control, wherein a support base is located on the electronic medicine storage case to retain and positionally fix medicine boxes. Moreover, indicator lights are correspondingly located on the support base and coupled to match medicine compartments, and the timing device is able to control flickering of each of the indicator lights, which further reminds a user the time to take medicine and indicates exact location of the medicine. The present invention is convenient to use, portable and is provided with effectiveness to remind the user the time to take medicine and indicate exact location of the medicine, and is applicable for use by elderly members and children of a family, hired nurses, and so on.

(b) Description of the Prior Art

The prior art of so-called “Medicine Case Structure” disclosed in the market primarily comprises a case frame and a plurality of medicine compartments that are inserted in the case frame, wherein internal layout of the case frame includes regularly arranged compartmental divisions that enable the medicine boxes to be inserted therein. A plurality of partitions are positioned upright within the case frame, thereby segmenting the interior of the case frame into a plurality of upright spaces. Transverse grooves are defined so as to be spaced at equal intervals in two sides of each of the singular spaces, which facilitate side protruding edgings on each of the medicine boxes to slot into the grooves and be inserted within the case frame, thereby eliminating the need for a transverse partition structure. A notch having an opening oriented towards a top of the medicine box is formed in a front panel of each of the medicine boxes, which enables the fingers to extend therein and pull out the medicine box. Furthermore, arched corners between a bottom panel of the medicine box and front and rear panels enable the fingers to easily retrieve medicine pills. Although the medicine case structure is provided the with effectiveness to easily retrieve medicine therefrom, however, for the group of uses, such as the aged, children, hired nurses, and so on, who are unlettered or patients who need to take numerous medicines at different times, then the times to take medicine can be easily forgotten or the wrong medicine taken, and so on. Hence, practical use of the prior art medicine case still does not meet the needs of the user.

### SUMMARY OF THE INVENTION

A primary objective of the present invention is to provide a microcomputer safe medication reminder manager with a configuration assembled by mutual disposition of an electronic medicine storage case and a timing device provided with multifunction control, wherein a support base is located on the electronic medicine storage case to retain and positionally fix medicine boxes. Moreover, indicator lights are correspondingly located on the support base and coupled to match medicine compartments, and the timing device is able to control flickering of each of the indicator lights, which further reminds a user the time to take medicine and indicates exact location of the medicine, thereby substantially increasing overall practicability, safety and convenience of the present invention.

Another objective of the present invention is to provide the microcomputer safe medication reminder manager with the timing device electrically connected to the electronic medicine storage case, wherein a display unit and a plurality of control keys are located on the timing device, which facilitate setting, displaying scheduled times for taking medicine and controlling flickering signals and character prompts reminding when to take medicine, and simultaneously controlling flickering of each corresponding indicator light. Moreover, a plurality of musical tunes built into the timing device can be configured to play at different fixed times to further facilitate reminding a user to take medicine, thereby increasing overall practicability and convenience of the present invention.

Yet another objective of the present invention is to provide the microcomputer safe medication reminder manager with a medicine sample display box, structured to provide for disposing medicine samples therein and marking with names of the medicines, function and dosage, which enable a user to precisely know what medicine sample and dosage he is taking, thereby avoiding taking the wrong medicine or wrong dosage, and increasing overall practicability and safety of the present invention.

Yet another objective of the present invention is to provide the microcomputer safe medication reminder manager with a plurality of weekly identifying musical tunes built into the timing device, and a Braille dot representation for the exclusive use of the sight impaired is located on each of the medicine compartments, thereby enabling those with impaired eyesight to conveniently distinguish the precise times to take medicine and identify the exact position of each of the medicine compartments, and increasing overall practicability and convenience of the present invention.

Yet another objective of the present invention is to provide the microcomputer safe medication reminder manager with a support base structured from an underplate, an upper cover and a fixing strip, thereby enabling convenient joining of a variety of medicine boxes thereto, and increasing practicability of use.

In order to achieve the aforementioned objectives, the microcomputer safe medication reminder manager of the present invention comprises the electronic medicine storage case and the timing device. The support base is located on the electronic medicine storage case, and the medicine boxes are located on the support base. The medicine boxes are separated into a plurality of medicine compartments, and the indicator lights are correspondingly located on the support base and coupled to match each of the medicine compartments. The timing device is electrically connected to the electronic medicine storage case, thereby enabling the timing device to control flickering of the corresponding indicator lights. Accordingly, the present invention is provided with convenience of use, portability and effectiveness to remind a user of times when to take medicine and exact location of the medicine, thereby increasing overall practicability, safety and convenience of the present invention.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of an embodiment according to the present invention.

FIG. 2 shows an exploded elevational view of the embodiment according to the present invention.

FIG. 3 shows a schematic view of the embodiment of the present invention in use.

### DETAILED DESCRIPTION OF THE PREFERRED EMBODIMENTS

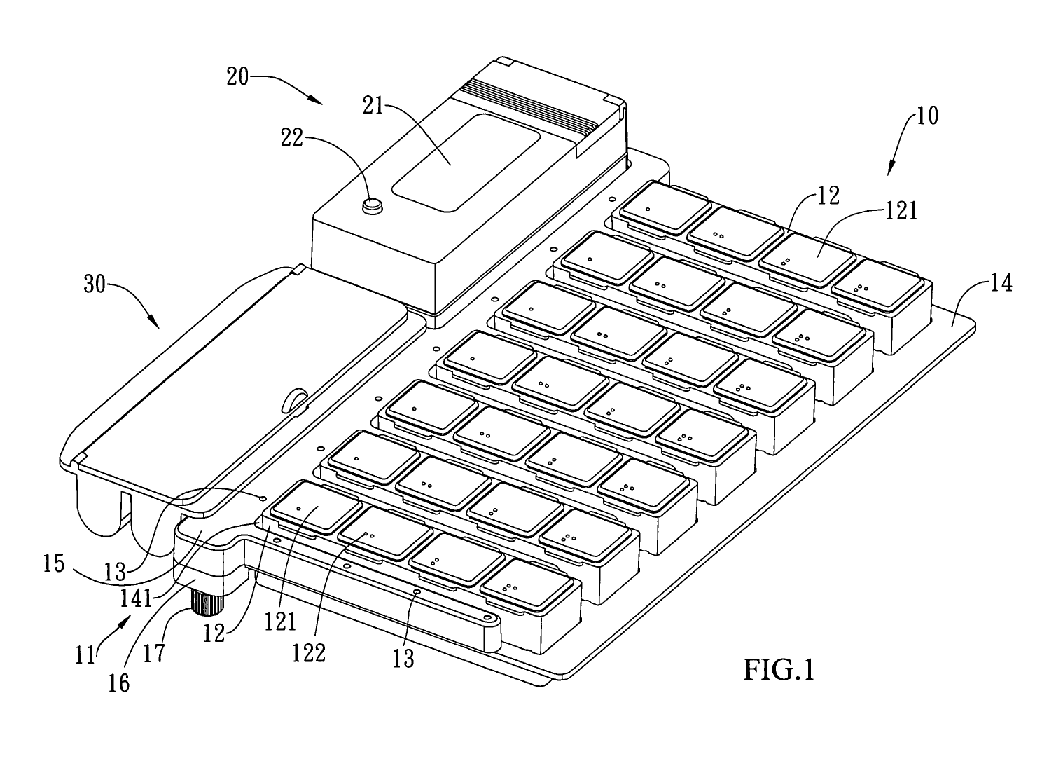

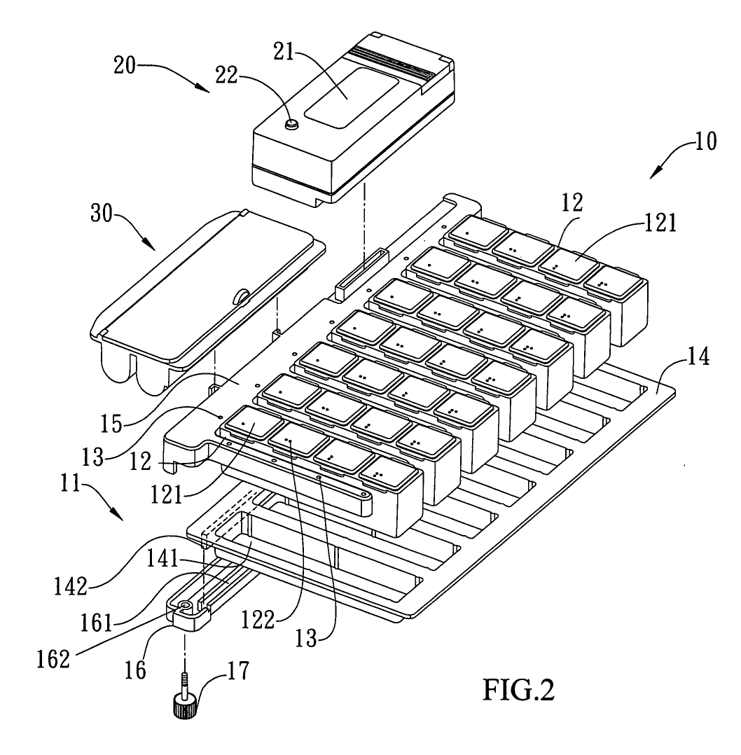

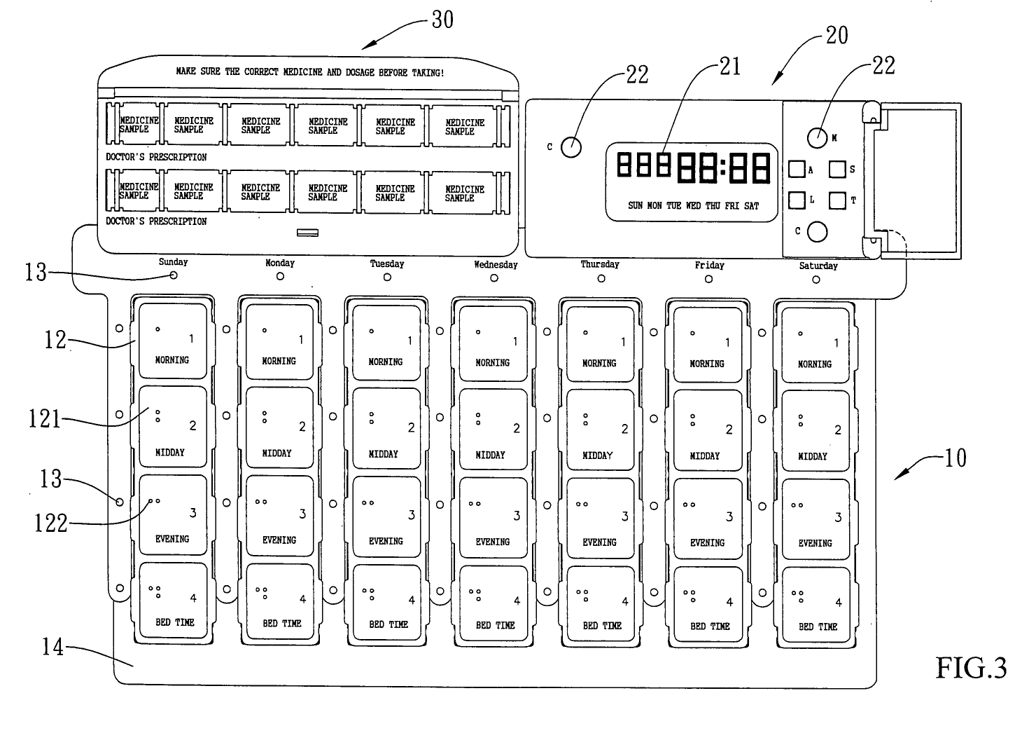

Referring to FIGS. 1, 2 and 3, which show a microcomputer safe medication reminder manager of the present invention, comprising:

An electronic medicine storage case 10, on which is located a support base 11. Medicine boxes 12 are located on the support base 11, each of which is segmented into a plurality of medicine compartments 121. The support base comprises an underplate 14, an upper cover 15 and a fixing strip 16. Retaining grooves 141 are defined in the underplate 14 to enable retaining and positionally fixing the medicine boxes 12 therein, and a protruding rib 142 is located on a rear side of the underplate 14. Indicator lights 13 are correspondingly located on the support base 11 and coupled to match each of the medicine compartments 121. The indicator lights 13 are respectively located on a front end of the medicine boxes 12 and lateral to the medicine compartments 121, which are able to indicate exact position of the medicine compartment 121 holding the medicine required. Moreover, a clasp groove 161 and a joining hole 162 are defined in the fixing strip 16, wherein the clasp groove 161 enables the protruding rib 142 of the underplate 14 to correspondingly clamp therein. The joining hole 162 of the fixing strip 16 enables screwing and joining together the upper cover 15 and the fixing strip 16 by means of a securing screw member 17, thereby firmly joining the underplate 14 between the upper cover 15 and the fixing strip 16. A Braille dot representation 122 for the exclusive special use of the sight impaired is formed on each of the medicine compartments 121, thereby enabling those with impaired eyesight to identify each of the medicine compartments 121. Furthermore, characters are correspondingly marked on the support base 11 and each of the medicine compartments 121 to represent exact times when the medicine should be taken.

A timing device 20 electrically connected to the electronic medicine storage case 10, and which is provided with a display unit 21 (which can be a liquid crystal display (LCD) or other display device) and a plurality of control keys 22 that enable the setting, display and control of flickering of corresponding indicator lights 13. A plurality of different musical tunes are built into the timing device 20, which can be played at different fixed times. Moreover, the timing device 20 can be provided with a plurality of built-in different weekly identifying musical tunes for recognition by the sight impaired.

Furthermore, the support base 11 can be further combined with a medicine sample display box 30 that provides for disposing medicine samples therein and for marking the medicine names, function and dosage of medicine.

Accordingly, the aforementioned structure configures the microcomputer safe medication reminder manager of the present invention. Referring to FIGS. 1, 2 and 3, the present invention is characterized in having a mutually configured structural assembly comprising the electronic medicine storage case 10 and the timing device 20 provided with multifunction control, wherein the support base 11 located on the electronic medicine storage case 10 enables retaining and positionally fixing the medicine boxes 12 thereon, and the indicator lights 13 located on the support base 11 correspond to each of the medicine compartments 121, thereby enabling the timing device 20 to control flickering of the corresponding indicator lights 13, which further remind a user the times when to take medicine and exact location of the medicine. Furthermore, the electrical connection between the timing device 20 and the electronic medicine storage case 10, the display unit 21 and the plurality of control keys 22 located on the timing device 20 enable convenient setting, displaying of scheduled times for talking medicine and control of flickering signals and character reminder prompts for when to take the medicine, and simultaneously controls flickering of the corresponding indicator lights 13 (for instance: when the time to take medicine on Sunday evening arrives, the Sunday indicator light 13 located on a front end of the medicine box 12 flickers, and the Sunday evening indicator light 13 located lateral to the medicine compartment 121 simultaneously, flickers, moreover, English letters appear on the display unit 21 or other symbols to remind the user, thereby enabling the user to select the exact location of the medicine at the specified times), and can be further set to play the plurality of different musical tunes built into the timing device 20 at the different fixed times. In addition, configuration of the medicine sample display box 30 enables marking the medicine names, function and dosage, which enable the user to precisely know what sample and dosage he is taking, thereby avoiding taking the wrong medicine or wrong dosage.

Furthermore, in order to enable the sight impaired to identify what medicine to take, the timing device 20 is provided with the built-in plurality of weekly identifying musical tunes, and the Braille dot representations 122 for the exclusive use of the sight impaired are respectively located on the medicine compartments 121, thereby enabling those with impaired eyesight to identify each of the medicine compartments 121.

Furthermore, the timing device 20 provided with multifunction control can be dismantled and singularly used as a general timing device.

Furthermore, the support base 11 comprising the underplate 14, the upper cover 15 and the fixing strip 16 enables convenient combining with and retaining a variety of medicine boxes.

In conclusion, the present invention is provided with convenience of use, portability and effectiveness to remind a user of times when to take medicine and exact location of the medicine, thereby increasing overall practicability, safety and practicability of the present invention.

According to the aforementioned detailed description, persons familiar with related art are able to easily understand that the present invention can clearly achieve the aforementioned objectives, and evidently comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A microcomputer safe medication reminder manager, comprising:
an electronic medicine storage case, on which is located a support base, and medicine boxes are located on the support base, each of which are segmented into a plurality of medicine compartments;
indicator lights are correspondingly located on the support base and coupled to match medicine compartments; and
a timing device electrically connected to the electronic medicine storage case;
whereby the timing device is able to control flickering of the corresponding indicator lights, thereby providing a reminder of when to take medicine and the exact location of the medicine.

2. The microcomputer safe medication reminder manager according to claim 1, wherein the support base comprises an underplate, an upper cover and a fixing strip, retaining grooves are defined in the underplate, which are used to retain and positionally fix the medicine boxes, a protruding rib is located on a rear side of the underplate, the indicator lights are correspondingly located on the support base and coupled to match each of the medicine compartments, moreover, a clasp groove and a joining hole are defined in the fixing strip; the clasp groove of the fixing strip enables correspondingly clasping of the protruding rib of the underplate therein, and the joining hole of the fixing strip enables screwing and joining together the upper cover and the fixing strip by means of a securing screw member, thereby firmly joining the underplate between the upper cover and the fixing strip.

3. The microcomputer safe medication reminder manager according to claim 1, wherein a display unit and a plurality of control keys are located on the timing device, which enable the setting, display and control of flickering of each of the corresponding indicator lights.

4. The microcomputer safe medication reminder manager according to claim 3, wherein the display unit is a liquid crystal display.

5. The microcomputer safe medication reminder manager according to claim 1, wherein a plurality of different musical tunes are built into the timing device that can be played at different fixed times.

6. The microcomputer safe medication reminder manager according to claim 1, wherein a plurality of different days of the week identifying musical tunes are built into the timing device, thereby enabling the sight impaired to recognize different times.

7. The microcomputer safe medication reminder manager according to claim 1, wherein a Braille dot representation for the exclusive use of eyesight impaired are located on each of the medicine compartments, thereby enabling those with impaired eyesight to distinguish the exact position of each of the medicine compartments.

8. The microcomputer safe medication reminder manager according to claim 2, wherein the indicator lights on the support base and coupled to match each of the medicine compartments are located at a front end to the medicine boxes and lateral to each of the medicine compartments, thereby indicating the exact location of the medicine.

9. The microcomputer safe medication reminder manager according to claim 1, wherein a medicine sample display box is further combined with the support base, which provides for disposing medicine samples therein and for marking the medicine names, function and dosage.

10. The microcomputer safe medication reminder manager according to claim 1, wherein the support base and each of the medicine compartments are correspondingly marked with characters to indicate the exact times to take medicine.
